(19) United States
(12) Patent Application Publication
(10) Pub. No.: US 2024/0163909 A1
(43) Pub. Date: May 16, 2024

(54) METHOD AND APPARATUS FOR SENSING AND SELECTION OF SIDELINK REFERENCE SIGNAL IN A WIRELESS COMMUNICATION SYSTEM

(71) Applicant: ASUS Technology Licensing Inc., Taipei City (TW)

(72) Inventors: Ming-Che Li, Taipei City (TW); Li-Chih Tseng, Taipei City (TW)

(21) Appl. No.: 18/504,039

(22) Filed: Nov. 7, 2023

Related U.S. Application Data
(60) Provisional application No. 63/424,519, filed on Nov. 11, 2022.

(51) Int. Cl. H04W 72/40; H04L 5/00; H04W 72/02; H04W 72/25

(52) U.S. Cl. CPC H04W 72/40; H04L 5/0051; H04W 72/02; H04W 72/25

(57) ABSTRACT

A method of a first device can comprise receiving a sidelink resource pool configuration of a sidelink resource pool for sidelink reference signal, wherein comb-N structure or design is applied or utilized for sidelink reference signal resources in one occasion in the sidelink resource pool, and wherein the sidelink resource pool configuration comprises or provides one or more frequency or comb offsets, among N frequency or comb offsets associated with the comb-N structure or design, for determining one or more usable, available, or candidate sidelink reference signal resources, selecting or determining a first sidelink reference signal resource, among the one or more usable, available, or candidate sidelink reference signal resources, in the one occasion, and performing a first sidelink reference signal transmission on the first sidelink reference signal resource and performing a first Sidelink Control Information (SCI) transmission for scheduling the first sidelink reference signal transmission in the one occasion.

### CROSS-REFERENCE TO RELATED APPLICATIONS

The present application claims priority to and the benefit of U.S. Provisional Patent Application Ser. No. 63/424,519, filed Nov. 11, 2022, which is fully incorporated herein by reference.

### FIELD

This disclosure generally relates to wireless communication networks and, more particularly, to a method and apparatus for sensing and selection of sidelink reference signal in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for sensing and selection of sidelink reference signal in a wireless communication system to mitigate interference for sidelink reference signal transmission/reception.

In various embodiments, a method of a first device can comprise receiving a sidelink resource pool configuration of a sidelink resource pool for sidelink reference signal, wherein comb-N structure or design is applied or utilized for sidelink reference signal resources in one occasion in the sidelink resource pool, and wherein the sidelink resource pool configuration comprises or provides one or more frequency or comb offsets, among N frequency or comb offsets associated with the comb-N structure or design, for determining one or more usable, available, or candidate sidelink reference signal resources, selecting or determining a first sidelink reference signal resource, among the one or more usable, available, or candidate sidelink reference signal resources, in the one occasion, and performing a first sidelink reference signal transmission on the first sidelink reference signal resource and performing a first Sidelink Control Information (SCI) transmission for scheduling the first sidelink reference signal transmission in the one occasion.

In various embodiments, a method of a network node can comprise transmitting or providing, to one or more devices, a sidelink resource pool configuration of a sidelink resource pool for sidelink reference signal, wherein comb-N structure or design is applied or utilized for sidelink reference signal resources in one occasion in the sidelink resource pool, and wherein the sidelink resource pool configuration comprises or provides one or more frequency or comb offsets, among N frequency or comb offsets associated with the comb-N structure or design, for the one or more devices to determine one or more usable, available, or candidate sidelink reference signal resources for transmitting sidelink reference signal.

In various embodiments, a method of a first device can comprise triggering or requesting a sensing-based resource (re-)selection for sidelink reference signal, determining a plurality of candidate resources for sidelink reference signal in a sidelink resource pool, determining or deriving a specific candidate resource being indicated or reserved by a received SCI from another UE, excluding the specific candidate resource from the plurality of candidate resources, excluding one or more additional candidate resources associated with the specific candidate resource from the plurality of candidate resources, selecting one or more resources from remaining candidate resources after exclusion, and performing one or more sidelink reference signal transmissions on the one or more resources

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 7, An example for Scheme 2 resource allocation for SL PRS, from R1-2211012, “Discussion on potential solutions for sidelink positioning”, Vivo.

FIG. 6 is a reproduction of FIG. 6: Mode 2 resource allocation for PSCCH and associated SL PRS, from R1-2211203, “Further discussion on potential solutions for SL positioning”, CATT, GOHIGH.

FIG. 7 is an example diagram showing, when sensing-based resource selection is triggered/requested in slot n, (the Physical layer of) a UE will have a (initial) set of candidate single-slot resources comprising multiple candidate single-slot resources, in accordance with embodiments of the present invention.

FIGS. 8A-8C are example diagrams showing multiple SL PRSs can be multiplexed within one PRB and one slot, in accordance with embodiments of the present invention.

FIG. 9 is an example diagram showing a PSSCH transmission comprising sub-channel 1 and 2 in a communication resource pool may induce interference on sub-channel 0 and/or sub-channel 3, in accordance with embodiments of the present invention.

FIG. 10 is a flow diagram of a method of a first device comprising triggering/requesting sensing-based resource (re-)selection for sidelink reference signal, determining a plurality of candidate resources, determining/deriving a specific candidate resource, excluding the specific candidate resource, excluding additional candidate resources, selecting one or more resources from remaining candidate resources, and performing one or more sidelink reference signal transmissions, in accordance with embodiments of the present invention.

FIG. 11 is a flow diagram of a method of a first device comprising having/being configured with configuration of a sidelink resource pool for sidelink reference signal, selecting/utilizing one sidelink reference signal resource in one occasion, and performing sidelink reference signal transmission on the one sidelink reference signal resource, in accordance with embodiments of the present invention.

FIG. 12 is a flow diagram of a method of a first device comprising receiving a sidelink resource pool configuration of a sidelink resource pool for sidelink reference signal, selecting or determining a first sidelink reference signal resource, and performing a first sidelink reference signal transmission on the first sidelink reference signal resource and performing a first SCI transmission, in accordance with embodiments of the present invention.

FIG. 13 is a flow diagram of a method of a network node comprising transmitting or providing a sidelink resource pool configuration of a sidelink resource pool for sidelink reference signal, in accordance with embodiments of the present invention.

FIG. 14 is a flow diagram of a method of a first device comprising triggering or requesting a sensing-based resource (re-)selection, determining a plurality of candidate resources for sidelink reference signal, determining or deriving a specific candidate resource, excluding the specific candidate resource, excluding one or more additional candidate resources, selecting one or more resources, and performing one or more sidelink reference signal transmissions, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TS 38.214 V17.1.0 (2022-03) 3GPP; TSG RAN; NR; Physical layer procedures for data (Release 17); [2] 3GPP TS 38.212 V17.1.0 (2022-03) 3GPP; TSG RAN; NR; Multiplexing and channel coding (Release 17); [3] 3GPP TS 38.211 V17.1.0 (2022-03) 3GPP; TSG RAN; NR; Physical channels and modulation (Release 17); [4] RP-213588, “Revised SID on Study on expanded and improved NR positioning”, Intel; [5] RAN1 Chair's Notes of 3GPP TSG RAN WG1 #109-e; [6] RAN1 Chair's Notes of 3GPP TSG RAN WG1 #110; [7] RAN1 Chair's Notes of 3GPP TSG RAN WG1 #110bis-e; [8] R1-2211012, “Discussion on potential solutions for sidelink positioning”, Vivo; and [9] R1-2211203, “Further discussion on potential solutions for SL positioning”, CATT, GOHIGH. The standards and documents listed above are hereby expressly and fully incorporated herein by reference in their entirety.

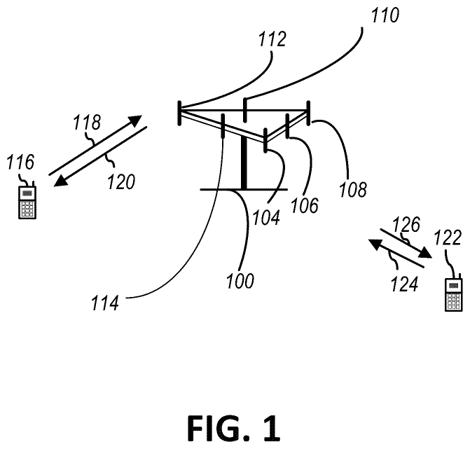

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

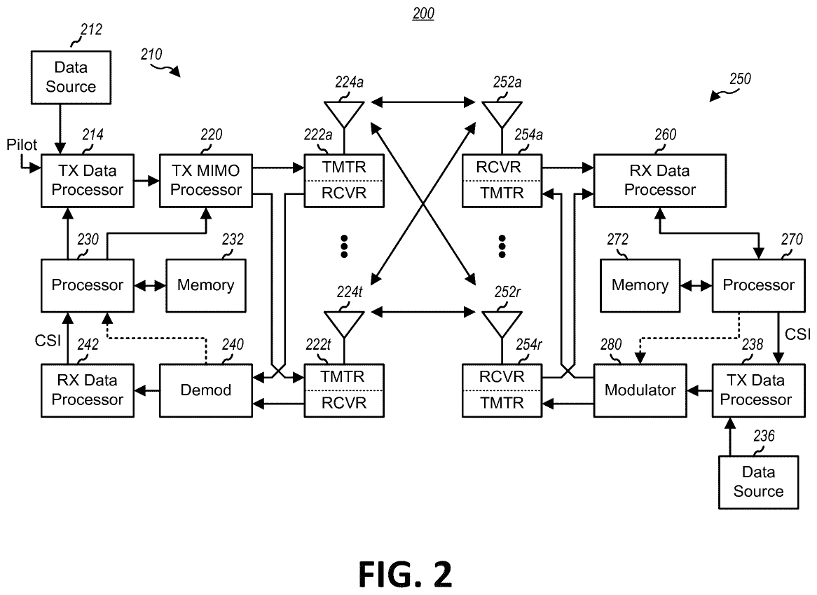

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

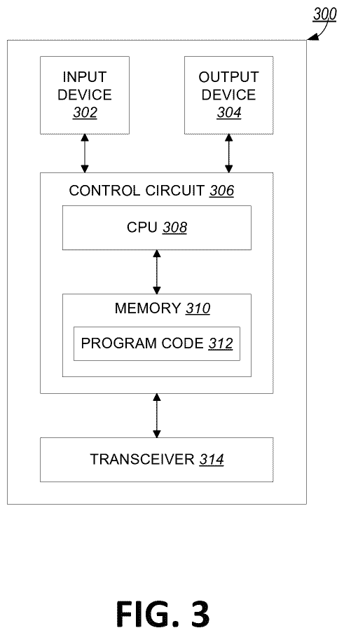

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

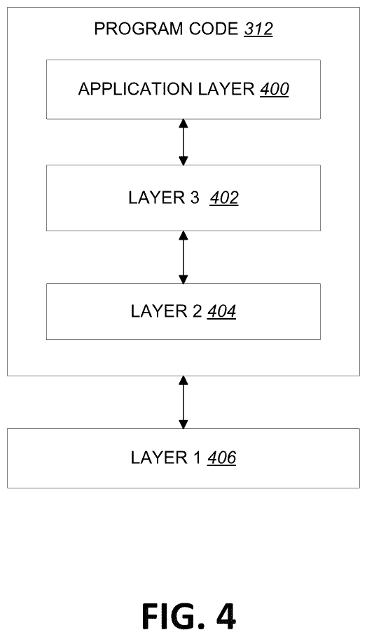

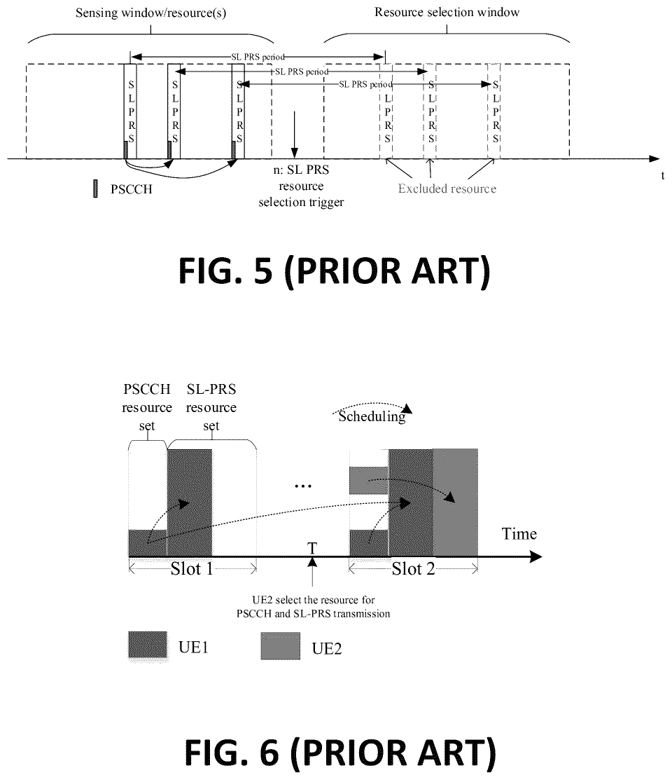

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In TS 38.214 ([1] 3GPP TS 38.214 V17.1.0 (2022-03) 3GPP; TSG RAN; NR; Physical layer procedures for data (Release 17)), SL related procedures for data is specified.

For New Radio (NR) Release-16/17 sidelink design, sidelink slots can be utilized for Physical Sidelink Broadcast Channel (PSBCH) or Physical Sidelink Control Channel (PSCCH)/Physical Sidelink Shared Channel (PSSCH)/Physical Sidelink Feedback Channel (PSFCH) transmission/reception. A sidelink (communication) resource pool will comprise a set of sidelink slots (except slots for PSBCH) and a set of frequency resources. Different sidelink (communication) resource pools may be Time Division Multiplexed (TDMed) and/or Frequency Division Multiplexed (FDMed). More specifically, a PSCCH in one sidelink (communication) resource pool can only schedule PSSCH resource(s) in the same one sidelink (communication) resource pool. A PSCCH in one sidelink (communication) resource pool is not able to schedule PSSCH resource(s) in another/other sidelink (communication) resource pool. For a PSCCH/PSSCH, associated PSFCH is in the same sidelink (communication) resource pool, rather than in different sidelink (communication) resource pools.

One sidelink (communication) resource pool will comprise multiple sub-channels in frequency domain, wherein a sub-channel comprises multiple contiguous Physical Resource Blocks (PRBs) in frequency domain. One PRB comprises multiple Resource Elements (REs), e.g., one PRB comprises 12 REs. Configuration of the sidelink resource pool will indicate the number of PRBs of each sub-channel in the corresponding sidelink resource pool. Sub-channel based resource allocation in frequency domain is supported for PSSCH. For a PSSCH resource scheduled by a PSCCH in the same sidelink slot, a fixed relationship between the PSCCH and the PSSCH resource is specified, which means that the PSCCH will be located in the lowest (index of) sub-channel of the scheduled PSSCH resource. As for scheduled PSSCH resource in different slot(s), the starting frequency position of the scheduled PSSCH resource will be scheduled/indicated by sidelink control information, instead of a fixed relationship.

In current NR Release-16/17 sidelink design, one Sidelink Control Information (SCI) could indicate at most three PSSCH resources via Frequency resource assignment and/or Time resource assignment in the SCI. The SCI may comprise a 1st stage SCI and a 2nd stage SCI. The 1st stage SCI may be transmitted via PSCCH. The 2nd stage SCI may be transmitted via multiplexed with the scheduled PSSCH resource in the same sidelink slot, e.g., the first PSSCH resource. In other words, the SCI can schedule at most two PSSCH resources in later sidelink slots, e.g., the second PSSCH resource and/or the third PSSCH resource. The at most three PSSCH resources are in different slots in a sidelink (communication) resource pool. The at most three PSSCH resources are within 32 consecutive slots in a sidelink resource pool. The at most three PSSCH resources are utilized/associated with a same data packet, e.g., a same Transport Block (TB) or a same Medium Access Control (MAC) Protocol Data Unit (PDU).

Moreover, resource reservation for another TB by a SCI could be (pre-)configured with/as enabled or not enabled or not configured in a sidelink (communication) resource pool. When a sidelink (communication) resource pool is configured with an enabled such resource reservation, the sidelink (communication) resource pool is configured with a set of reservation period values. The possible reservation period could be 0, 1:99, 100, 200, 300, 400, 500, 600, 700, 800, 900, 1000 ms. The resource reservation period field in a SCI in the sidelink (communication) resource pool could indicate which/the reservation period value for (future) resource reservation. The size/number of the set of reservation period values could be from 1 to 16.

In current NR Release-16/17 sidelink design, there are two sidelink resource allocation modes defined for NR sidelink communication:
Mode 1 is that the base station/network node can schedule sidelink resource(s) to be used by User Equipment (UE) for sidelink transmission(s);
Mode 2 is that the UE determines (i.e., base station/network node does not schedule) sidelink transmission resource(s) within sidelink resources configured by the base station/network node or pre-configured sidelink resources.

For network scheduling mode, e.g. NR sidelink resource allocation mode 1, the network node may transmit a Sidelink (SL) grant, e.g., Downlink Control Information (DCI) format 3_0, on Uu interface for scheduling at most three PSSCH resources (for a same data packet). The sidelink grant comprises a “time gap” field and “Lowest index of the subchannel allocation to the initial transmission” fields for indicating the first PSSCH resource and/or the PSCCH resource in the specific slot, and also comprises a “Frequency resource assignment” field and a “Time resource assignment” field for indicating the second PSSCH resource and/or the third PSSCH resource (if any). The sidelink grant also comprises “resource pool index” for indicating one sidelink (communication) resource pool, wherein the scheduled at most three PSSCH resources are within the indicated one sidelink (communication) resource pool. The Transmission (TX) UE may perform PSCCH and PSSCH transmissions on PC5 interface, in response to the received sidelink grant, for a data packet. The Uu interface means the wireless interface for communication between network and UE. The PC5 interface means the wireless interface for communication (directly) between UEs/devices.

For UE (autonomous) selection mode, e.g. NR sidelink resource allocation mode 2, since transmission resource is not scheduled via network node, the UE may require performing sensing before selecting a resource for transmission (e.g., sensing-based transmission), in order to avoid resource collision and interference from, or to/with, other UEs (especially UEs using NR sidelink). Full sensing is supported in NR Rel-16 sidelink, while partial sensing is supported in NR Rel-17 sidelink. Based on the result of the sensing procedure, the UE can determine a valid/identified resource set. The valid/identified resource set may be reported to higher layers (of the UE). The UE may (randomly) select one or multiple valid/identified resources from the valid/identified resource set to perform sidelink transmission(s) from the UE. The sidelink transmission(s) from the UE may be a PSCCH and/or PSSCH transmission.

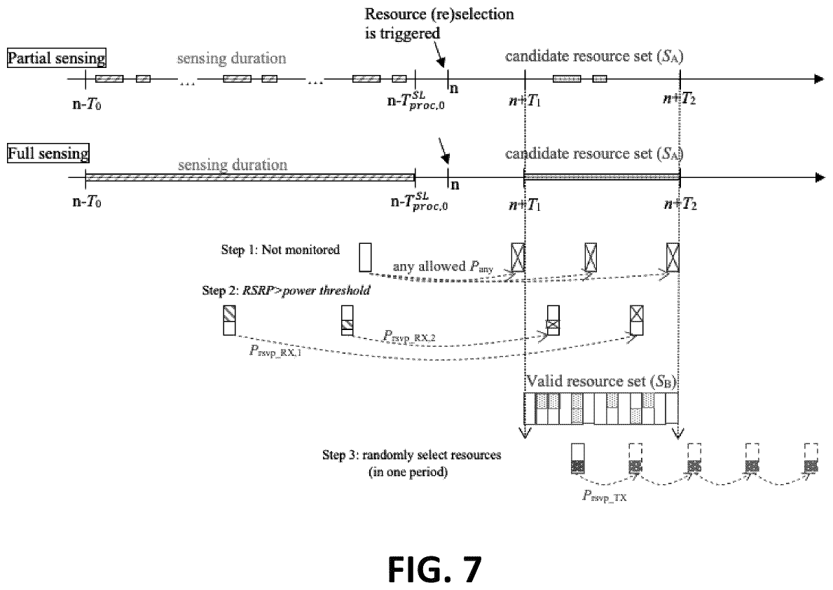

As shown in the instance of FIG. 7, when sensing-based resource selection is triggered/requested in slot n, (the Physical layer of) the UE will have a (initial) set of candidate single-slot resources comprising multiple candidate single-slot resources. The available (initial) set of candidate single-slot resources is restricted with time interval [n+T₁,n+T₂], which may be called a resource selection window. Preferably in certain embodiments, one candidate single-slot resource may comprise one or multiple frequency resource units within one slot, wherein the frequency resource unit may be a sub-channel. As specified in TS 38.214 ([1] 3GPP TS 38.214 V17.1.0 (2022-03) 3GPP; TSG RAN; NR), a candidate single-slot resource for transmission R_{x,y} is defined as a set of L_{subCH} contiguous sub-channels with sub-channel x+j in slot t′_{y}^{SL} where j=0, . . . , L_{subCH}−1. Note that Transmission Time Interval (TTI) may be a slot in NR.

If full sensing is performed (e.g., [1] 3GPP TS 38.214 V17.1.0 (2022-03) 3GPP; TSG RAN; NR), e.g. partially sensing is not configured, the (initial) set of candidate single-slot resources are in the (full) time interval [n+T₁,n+T₂]. The (Physical layer of the) UE shall monitor/sense slots within sensing window [n−T₀,n−T_{proc,0}^{SL}].

When partial sensing is performed/configured (e.g., [1] 3GPP TS 38.214 V17.1.0 (2022-03) 3GPP; TSG RAN; NR), (the Physical layer of) the UE determines by its implementation a set of candidate slots which comprise at least Y candidate slots within the time interval [n+T₁,n+T₂], wherein the (initial) set of candidate single-slot resources are in the set of slots. For periodic-based partial sensing, if a slot t′_{y}^{SL} is in the set of candidate slots, (the Physical layer of) the UE shall monitor/sense any slot t′_{y-k×P′}_{ᵣₑₛₑᵣᵥₑ}^{SL} within sensing window. For contiguous partial sensing, (the Physical layer of) the UE shall monitor/sense slots [n+T_{A},n+T_{B}] within sensing window, wherein T_{A} and T_{B} are both selected such that (the Physical layer of) the UE has sensing results starting at least M consecutive logical slots before the first slot of the selected Y candidate slots.

Based on sensing result, (the Physical layer of) the UE may generate a valid/identified resource set, wherein the valid/identified resource set is a subset of the (initial) set of candidate single-slot resources. The generation of the valid/identified resource set may be performed via excluding some candidate single-slot resources from the (initial) set of candidate single-slot resources, for instance the step 1 and step 2 shown in FIG. 7. If remaining candidate single-slot resources after exclusion steps is smaller than X (e.g., either of 20%, 35%, 50% depending on prio_{TX}, which association is configured in sidelink resource pool configuration) of the number of the (initial) set of candidate single-slot resources, UE may re-perform the exclusion step via increasing power threshold by 3 dB. After that, (the Physical layer of) the UE can determine the valid/identified resource set. The resource selection for sidelink transmission, performed by higher layer (MAC layer) of the UE, may be randomly selected from the valid/identified resource set, for instance the step 3 shown in FIG. 7.

As specified in [1] 3GPP TS 38.214 V17.1.0 (2022-03) 3GPP; TSG RAN; NR, the first excluding step is that if (the Physical layer of) the UE does not monitor/sense a TTI z, (the Physical layer of) the UE cannot expect whether the candidate single-slot resources in TTI “z+P_{any}” are occupied or not, wherein P_{any} means any possible periodicity configured in the sidelink (communication) resource pool. For instance, the first excluding step is shown as the step 1 in FIG. 7. The (Physical layer of) the UE excludes the candidate single-slot resources in TTI “z+q·P_{any}” and excludes the candidates single-slot resources for which other/another UE(s) may have possible transmission occurred in TTI “z+q·P_{any}”, wherein q is 1 or 1, 2, . . . , ┌T_{scal}/P_{rsvp_RX}┐. The parameter q means that the UE excludes multiple candidate single-slot resources with period P_{rsvp_RX} within time interval [z,z+T_{scal}].

The second excluding step is that if (the Physical layer of) the UE receives/detects a sidelink control signaling (e.g., SCI format 1) in a TTI m, (the Physical layer of) the UE may exclude the candidate single-slot resources according to the received sidelink control signaling. For instance, the second excluding step is shown as the step 2 in FIG. 7. More specifically, if (the Physical layer of) the UE receives/detects a sidelink control signaling scheduling a transmission in a TTI m and the measurement result for the sidelink control signaling is higher than a power threshold, (the Physical layer of) the UE may exclude the candidate single-slot resources according to the received sidelink control signaling. The measurement result may be Reference Signal Received Power (RSRP). More specifically, the measurement result may be PSCCH-RSRP or PSSCH-RSRP. The sidelink control signaling may schedule/indicate the resources of the scheduled transmission and/or periodicity of the scheduled transmission, P_{rsvp_RX}. The excluded candidate single-slot resources according to the received sidelink control signaling are the resources of the next one or multiple scheduled transmission(s) based on the resources of the scheduled transmission and/or periodicity of the scheduled transmission. The next multiple scheduled transmissions may be with period P_{rsvp_RX} within time interval [z,z+T_{scal}]. The power threshold is determined based on prio_{RX} (priority value indicated by the received sidelink control signaling) and prio_{TX} (priority value provided by the UE's higher layer). The association between the power threshold and (prio_{RX}, prio_{TX}) is configured by higher layer (e.g., configuration of the sidelink (communication) resource pool).

Note that in the NR sensing procedure, the UE does not measure Sidelink Received Signal Strength Indicator (S-RSSI) and does not determine the valid/identified resource set based on ranking of linear average of S-RSSI measured metric. Such difference from the Long-Term Evolution (LTE)/LTE-A sensing procedure is because NR sidelink can support SL pathloss-based power control (while LTE/LTE-A sidelink supports DL pathloss-based power control), such that interference between sidelink sub-channel(s) will be mitigated. Thus, the NR sensing procedure does not include S-RSSI measurement and ranking as with LTE/LTE-A.

In NR Release 17 (e.g., [3] 3GPP TS 38.211 V17.1.0 (2022-03) 3GPP; TSG RAN; NR; Physical channels and modulation), positioning on Uu interface is introduced. Downlink (DL) Positioning Reference Signal (PRS) and Uplink (UL) Sounding Reference Signal-Positioning (SRS-Pos) are specified as Positioning RS for supporting NR positioning functionality. Some positioning methods are introduced, such as Time Difference Of Arrival (TDOA), Round Trip Time (RTT), Angle of Arrival (AoA), and/or Angle of Departure (AoD). For time-based positioning methods, larger bandwidth for Positioning RS is required for higher accuracy positioning.

In NR Release-18 (e.g., [4] RP-213588), study on “NR Positioning Enhancements” will investigate higher accuracy, lower latency location, high integrity, and reliability requirements resulting from new applications and industry verticals for 5G. It will also study feasibility of potential solutions for SL positioning, considering relative positioning, ranging, and absolute positioning, wherein the SL positioning is operated in a device-to-device interface or said PC5-interface between device and device. The device can mean or can be replaced as UE.

In RAN1 #109-e, #110, #110bis-e meetings (e.g., [5] RAN1 Chair's Notes of 3GPP TSG RAN WG1 #109-e; [6] RAN1 Chair's Notes of 3GPP TSG RAN WG1 #110; [7] RAN1 Chair's Notes of 3GPP TSG RAN WG1 #110bis-e;), RAN1 agreed to study RTT-type solutions using SL, SL-AoA, SL-TDOA, SL-AoD with regard to positioning methods supported using SL measurements. Accordingly, a new reference signal for SL positioning/ranging will be introduced, and existing DL PRS or UL SRS-Pos design and SL design framework can be used as a starting point. The new reference signal for SL positioning/ranging may be noted as Sidelink Positioning Reference Signal (SL PRS or SL-PRS). For supporting time-based positioning methods, larger bandwidth for SL PRS is required for higher accuracy positioning. It is quite possible that the required bandwidth for SL PRS may be 10 MHz, 20 MHz, or even more. Such larger bandwidth will be hard to be multiplexed with PSCCH/PSSCH, and even hard to be confined within one sidelink resource pool with PSCCH/PSSCH resources (e.g., within NR Release-16/17 sidelink resource pool). Thus, with regard to the SL Positioning resource allocation (e.g., [5] RAN1 Chair's Notes of 3GPP TSG RAN WG1 #109-e), RAN1 will study further Option 1: Dedicated resource pool for SL PRS and Option 2: Shared resource pool with sidelink communication (i.e., PSCCH/PSSCH and/or PSFCH). Moreover, some sidelink control information may be provided by the TX UE for scheduling/indicating/allocating SL PRS resources (e.g., [7] RAN1 Chair's Notes of 3GPP TSG RAN WG1 #110bis-e), in order to let the Reception (RX) UE know where/when to receive/measure corresponding SL PRS. The sidelink control information for scheduling/indicating/allocating SL PRS resources may be multiplexed in the dedicated resource pool for SL PRS of option 1, or be transmitted on PSCCH in other sidelink resource pool with sidelink communication.

Furthermore, given the larger bandwidth requirement of SL PRS, Comb-N SL PRS design can be supported for providing more available SL PRS resources, and configured/adjusted symbol number can be supported as one SL PRS occasion. The potential candidate value of N may be 1, 2, 4, 6, 8, or 12. According to RAN1 #109-e (e.g., [5] RAN1 Chair's Notes of 3GPP TSG RAN WG1 #109-e), there are at least some possible designs of SL PRS pattern, given M symbol and comb-N:
Fully staggered SL PRS patterns, M=N, and at each symbol a different RE offset is used,
Partially staggered SL PRS patterns, M<N, at each symbol a different RE offset is used,
Unstaggered SL PRS patterns, N>1, at each symbol a same RE offset is used.

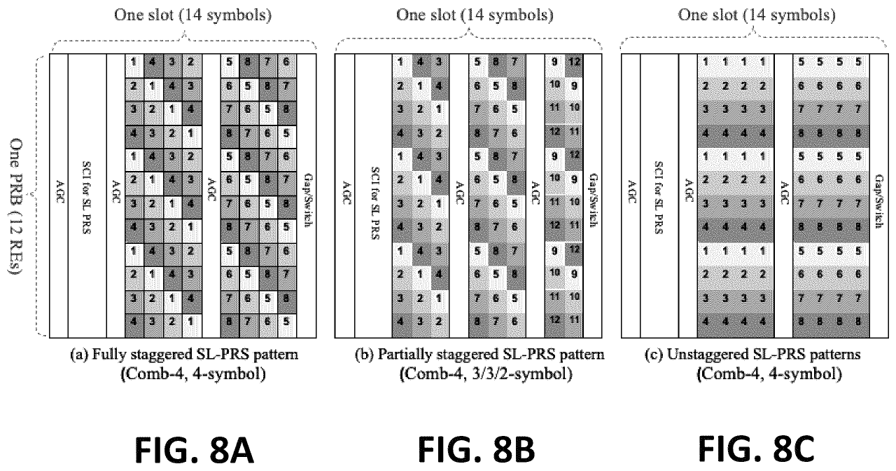

As shown in the instances of FIGS. 8A-8C, for option 1, multiple SL PRSs can be multiplexed within one PRB and one slot. Note that one SL PRS will occupy a lot of contiguous PRBs, e.g., 50 PRBs for 10 MHz bandwidth with 15 kHz subcarrier spacing. FIGS. 8A-8C just show SL PRS patterns within one PRB. Preferably in certain embodiments, the first symbol may be utilized for Automatic Gain Control (AGC). For one SL PRS pattern, the (immediately) preceding symbol may or may not be utilized for AGC. The last symbol may be utilized as a gap symbol for a possible TX/RX switch. For one SL PRS pattern, the (immediately) preceding symbol may or may not be utilized for a possible TX/RX switch, depending on future design. Preferably in certain embodiments, 0˜3 symbols may be utilized for transmitting SCI for SL PRS, depending on future design on how to transmit the SCI for SL PRS. For the case of no symbol for transmitting SCI for SL PRS in the dedicated resource pool for SL PRS, the SCI for SL PRS may be transmitted on PSCCH in other/another sidelink resource pool with sidelink communication.

As shown in the instance of FIG. 8A, when fully staggered SL PRS pattern of M=N=4 is applied for SL PRS pattern, and when there are two SL PRS occasions within one slot, 8 SL PRSs may be multiplexed with different index 1˜8. Each SL PRS may be derived or determined based on associated frequency offset (in unit of RE). For the former SL PRS occasion, 4 SL PRSs with index 1˜4 may be derived or determined based on associated frequency offset. For instance, SL PRS with index 4 is derived or determined based on frequency offset=0. SL PRS with index 2 is derived or determined based on frequency offset=2. For the later SL PRS occasion, 4 SL PRSs with index 5˜8 may be derived or determined based on associated frequency offset. For instance, SL PRS with index 8 is derived or determined based on frequency offset=0. SL PRS with index 5 is derived or determined based on frequency offset=3.

As shown in the instance of FIG. 8B, when partially staggered SL PRS pattern of N=4, M=3/3/2 for three SL PRS occasions is applied for SL PRS pattern, 12 SL PRSs may be multiplexed with a different index 1˜12. Each SL PRS may be derived or determined based on associated frequency offset (in unit of RE).

As shown in the instance of FIG. 8C, when unstaggered SL PRS pattern of N=4, M=4 is applied for SL PRS pattern, and when there are two SL PRS occasions within one slot, 8 SL PRSs may be multiplexed with a different index 1˜8. Each SL PRS may be derived or determined based on associated frequency offset (in unit of RE). For instance, SL PRS with index 4 is derived or determined based on frequency offset=0 in the former SL PRS occasion. SL PRS with index 2 is derived or determined based on frequency offset=2 in the former SL PRS occasion. For instance, SL PRS with index 8 is derived or determined based on frequency offset=0 in the later SL PRS occasion. SL PRS with index 7 is derived or determined based on frequency offset=1 in the later SL PRS occasion.

Note that the indexes shown in FIGS. 8A-8C are just examples. Other ordering/indexing is possible.

Preferably in certain embodiments, for comb-N SL PRS design/structure, possible frequency offsets may be 0 to (N−1).

According to RAN1 #110 (e.g., [6] RAN1 Chair's Notes of 3GPP TSG RAN WG1 #110), scheme 1 and scheme 2 are introduced for SL PRS resource allocation.
Scheme 1: Network-centric operation SL PRS resource allocation (e.g. similar to a legacy NR Mode 1 solution)
   The network (e.g. Next Generation Node B (gNB), Location Management Function (LMF), gNB & LMF) allocates resources for SL PRS.
Scheme 2: UE autonomous SL PRS resource allocation (e.g. similar to legacy NR Mode 2 solution)
   At least one of the UE(s) participating in the sidelink positioning operation allocates resources for SL PRS

For scheme 1, the network node may transmit a SL grant for scheduling SL PRS resource(s). However, SL PRS resource may be multiplexed via RE level, while PSSCH are multiplexed via sub-channel level. Moreover, SL PRS resources may be in dedicated resource pool for SL PRS, while PSSCH is in sidelink communication resource pool (or said sidelink resource pool with sidelink communication). Thus, one proposal is to (1) define extra fields in DCI format 3_0 (i.e., current sidelink grant for scheduling PSSCH resource) to load SL PRS resource information, or (2) define a new DCI format exclusively for SL PRS resource information, wherein the new DCI format is with Cycle Redundancy Check (CRC) scrambled by ‘SL PRS-Radio Network Temporary Identifier (RNTI)’.

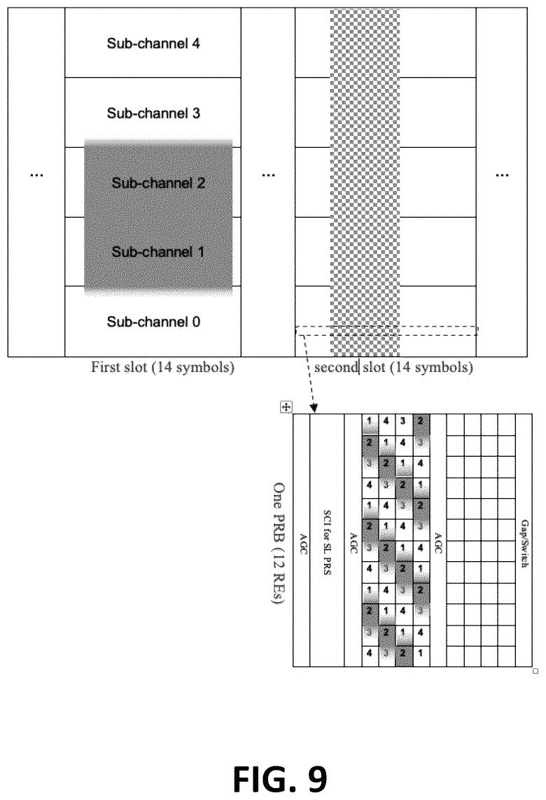

For scheme 2, if the concept of legacy NR Mode 2 is applied (e.g., [6] RAN1 Chair's Notes of 3GPP TSG RAN WG1 #110), the UE may perform sensing on SL PRS resources in sensing duration, and then exclude candidate SL PRS resources based on sensing result. After the exclusion step, the UE may determine valid candidate SL PRS resources and then randomly select some candidate SL PRS resource(s) from that, as proposed in some contributions (e.g., [8] R1-2211012 and [9] R1-2211203). However, SL PRS resource may be multiplexed via RE level, while PSSCH are multiplexed via sub-channel level. For an instance when sub-carrier spacing (SCS)=15 kHz, assuming one sub-channel is configured to comprise 10 PRBs (one PRB comprises 12 consecutive REs in frequency domain). Two adjacent PSSCH transmissions in the same slot may interfere, with each other, in some neighboring REs. Considering the bandwidth of PSSCH transmission, such interference may be negligible or acceptable. However, two adjacent SL PRS transmission in the same slot may severely interfere with each other, e.g., SL PRS with index 2 and SL PRS with index 3 in FIGS. 8A-8C. Moreover, when UE (relative) mobility is higher, Doppler frequency shift will be larger. For the instance shown in FIG. 9, in the first slot, one PSSCH transmission comprising sub-channel 1 and 2 in a communication resource pool may induce interference (shown as gradient gray part) on sub-channel 0 and/or sub-channel 3. In the second slot, one SL PRS transmission comprising SL PRS resource index 2 may induce interference (shown as gradient gray part) on SL PRS resource index 1 and 3. Such interference due to the SL PRS transmission will impact on all PRBs comprised by the SL PRS transmission. Thus, it can be expected that SL PRS transmission/reception/measurement will encounter interference issues, which is more severe than PSSCH transmission/reception. Note that when the TX UE transmits sidelink transmission (PSSCH or SL PRS), the interference may be induced/generated due to signal leakage or side-lobe, e.g., higher UE transmit power or worse UE capability/hardware, higher interference power/region. When the RX UE receives the sidelink transmission (PSSCH or SL PRS), the interference may be (also) induced/generated due to Doppler frequency shift impact, e.g., higher UE (relative) mobility, higher Doppler frequency shift.

To deal with the above issues, various concepts, mechanisms, methods, and embodiments are provided as follows.

### Concept A

The concept A is that for sensing-based resource (re-)selection for sidelink reference signal, when the UE determines/derives a specific candidate resource being indicated or reserved by a received SCI from another/other UE, the UE may exclude the specific candidate resource and also exclude additional candidate resource(s). The additional candidate resource(s) are in the same occasion as the specific candidate resource (in time domain). The additional candidate resource(s) are adjacent/neighbored/close to the specific candidate resource (in frequency domain).

Preferably in certain embodiments, the UE may have a configuration of a sidelink resource pool for sidelink reference signal. The sidelink resource pool for sidelink reference signal may be enabled/configured/supported for sidelink reference signal transmission/reception. The sidelink resource pool for sidelink reference signal may be in/within a carrier/cell or a sidelink Bandwidth Part (BWP).

Preferably in certain embodiments, the UE may trigger/request sensing-based resource (re-)selection, in a first slot n, for sidelink reference signal. Preferably in certain embodiments, the UE may trigger/request the sensing-based resource (re-)selection for sidelink reference signal with one priority value (of UE's own sidelink reference signal). Preferably and/or alternatively, the UE may trigger/request the sensing-based resource (re-)selection for sidelink reference signal with one periodicity. Preferably and/or alternatively, the UE may trigger/request the sensing-based resource (re-)selection for sidelink reference signal with a required (minimum) bandwidth or a number of frequency units (e.g., PRBs or sub-channels). Preferably in certain embodiments, (in response to the trigger/request,) the UE may determine a plurality of candidate occasions for sidelink reference signal in the sidelink resource pool. Preferably in certain embodiments, the plurality of candidate occasions for sidelink reference signal may be within a resource selection window/duration, e.g., a time interval [n+T_{SL_PRS_1},n+T_{SL_PRS_2}]. The UE may determine a plurality of candidate resources for sidelink reference signal, which are/comprises (all) sidelink reference signal resources in the plurality of candidate occasions in the sidelink resource pool. In other words, (all) sidelink reference signal resources in the plurality of candidate occasions in the sidelink resource pool may be considered/set/determined as candidate resources for sidelink reference signal (in the plurality of candidate sidelink reference signal resources). Preferably in certain embodiments, T_{SL_PRS_1} may be (pre-)configured (e.g., via the configuration of the sidelink resource pool for sidelink reference signal or via UE configuration for sidelink reference signal) or specified. Preferably in certain embodiments, T_{SL_PRS_2} may be (pre-)configured (e.g., via the configuration of the sidelink resource pool for sidelink reference signal or via UE configuration for sidelink reference signal), or specified, or determined/derived based on the latency requirement of transmitting the sidelink reference signal.

Preferably in certain embodiments, the UE may determine a set of valid/identified candidate resources for sidelink reference signal, from the plurality of candidate resources for sidelink reference signal, based on sensing result. Preferably in certain embodiments, the UE may determine the set of valid/identified candidate resources based on the sensing result within a sensing window/duration, e.g., a time interval [n−T_{SL_PRS_0},n−T_{SL_PRS_proc0}]. Preferably in certain embodiments, T_{SL_PRS_0} may be (pre-)configured (e.g., via the configuration of the sidelink resource pool for sidelink reference signal or via UE configuration for sidelink reference signal) or specified. Preferably in certain embodiments, T_{SL_PRS_proc0} may be (pre-)configured (e.g., via the configuration of the sidelink resource pool for sidelink reference signal, or via UE configuration for sidelink reference signal, or based on UE capability) or specified. Preferably in certain embodiments, the UE may exclude one or more candidate resources, among/from the plurality of candidate resources, based on the sensing result. Preferably in certain embodiments, the UE may exclude one or more candidate resources based on received SCI(s) from other UE(s) and/or non-monitoring slot(s).

Preferably in certain embodiments, if/when a specific candidate resource is indicated or reserved by a received SCI from another/other UE, the UE may exclude the specific candidate resource from the plurality of candidate resources. Preferably in certain embodiments, RSRP associated with the received SCI may be larger than or equal to a power threshold. Preferably and/or alternatively, RSRP associated with a sidelink reference signal transmission, which is scheduled by the received SCI and in the same slot/TTI as the received SCI, may be larger than or equal to a power threshold. The power threshold may be determined/derived based on the one priority value and/or another priority value indicated by the received SCI. According to concept B, the UE may also exclude additional candidate resource(s) from the plurality of candidate resources. Preferably in certain embodiments, the additional candidate resource(s) may be in the same occasion as the specific candidate resource. Preferably in certain embodiments, the additional candidate resource(s) and the specific candidate resource may comprise the same PRB(s) or sub-channel(s) in frequency domain. Preferably in certain embodiments, the additional candidate resource(s) and the specific candidate resource may comprise different (non-overlapped) REs. More specifically, the additional candidate resource(s) may comprise different REs which are adjacent/neighbored/close to the specific candidate resource. The additional candidate resource(s) may be associated with frequency/comb offset(s) which are adjacent/neighbored/close to a frequency/comb offset associated with the specific candidate resource. Preferably in certain embodiments, if/when the RSRP is higher (e.g., larger than another threshold), the additional candidate resource(s) may be more. Preferably and/or alternatively, if/when mobility is even higher (e.g., the UE mobility, mobility of another UE/destination, or (relative) mobility to another UE/destination), the additional candidate resource(s) may be more. Preferably and/or alternatively, if/when (expect) Doppler frequency offset is larger, the additional candidate resource(s) may be more. The UE may determine/derive the additional candidate resources based on the (expect) Doppler frequency offset. For instance, the UE may determine/derive the additional candidate resources based on the specific candidate resource with adding/subtracting the (expect) Doppler frequency offset. Preferably and/or alternatively, the number of the additional candidate resource(s) may be determined/derived by UE implementation. For the instance shown in FIG. 9, when the UE determines/derives the SL PRS resource index 2 in the second slot being reserved by a received SCI from another/other UE, the UE may exclude a candidate resource on the SL PRS resource index 2 in the second slot. The UE may also exclude candidate resources on the SL PRS resource index 1 and 3 in the second slot. If the RSRP is higher than the another threshold or if the (expect) Doppler frequency offset is larger than one subcarrier spacing, the UE may also exclude candidate resources on the SL PRS resource index 1, 3 and 4 in the second slot.

Preferably in certain embodiments, if/when the UE does not monitor/sense a TTI z, the UE cannot expect whether (all) specific candidate resources in TTI “z+P_{any}” are occupied/reserved by another/other UE(s), wherein P_{any} may mean any possible periodicity configured/enabled in the sidelink resource pool. The UE may exclude (all) the specific candidate resources in TTI “z+P_{any}” from the plurality of candidate resources.

Preferably in certain embodiments, the UE may determine the set of valid/identified candidate resources, from some (remaining) candidate resources after the exclusion. Preferably in certain embodiments, the set of valid/identified candidate resources may comprise (all or part of) the some (remaining) candidate resources after the exclusion.

The set of valid/identified candidate resources may be reported to higher layer(s) of the UE. (The higher layer(s) of) the UE may determine/select one or more resources from the set of valid/identified candidate resources. The UE may perform one or more sidelink reference signal transmissions on the one or more resources. Preferably in certain embodiments, the one or more resources may be in different TTIs/occasions for sidelink reference signal.

Preferably in certain embodiments, the occasion for sidelink reference signal may comprise a number M of consecutive symbols in time domain. The number M of consecutive symbols for one occasion may be within one slot of the sidelink resource pool. The number M may be specified, indicated, or configured (e.g., configured in the configuration of the sidelink resource pool for sidelink reference signal or via UE configuration for sidelink reference signal). Preferably in certain embodiments, when the sidelink reference signal applies/utilizes comb-N structure/design, the number M may be smaller than or equal to the value N.

Preferably in certain embodiments, the UE performs the one or more sidelink reference signal transmissions in NR. Preferably in certain embodiments, when the UE performs sensing-based resource selection for sidelink reference signal, the UE may exclude the additional candidate resource(s) for determining/derive the set of valid/identified candidate resources for sidelink reference signal. Preferably in certain embodiments, when the UE performs another sensing-based resource selection for sidelink data transmission (e.g., PSSCH transmission), the UE does not exclude additional candidate resource(s) for determining/derive another set of valid/identified candidate resources for sidelink data transmission.

Preferably in certain embodiments, the sidelink resource pool for sidelink reference signal may not comprise sidelink resources for PSSCH or sidelink data transmission. Alternatively, the sidelink resource pool for sidelink reference signal may comprise sidelink resources for PSSCH or sidelink data transmission.

### Concept B

Assuming comb-N structure/design is applied/utilized for a set of sidelink reference signal resources in one occasion in a sidelink resource pool for sidelink reference signal. The set of sidelink reference signal resources may be separated/multiplexed with different frequency/comb offsets. The set of sidelink reference signal resources may be separated/multiplexed with RE level. For instance, the set of sidelink reference signal resources comprises a first sidelink reference signal resource with a first frequency/comb offset and a second sidelink reference signal resource with a second frequency/comb offset. The first frequency/comb offset is different from the second frequency/comb offset. Preferably in certain embodiments, the first sidelink reference signal resource and the second sidelink reference signal resource may comprise the same PRB(s) or sub-channel(s) in frequency domain. The first sidelink reference signal resource and the second sidelink reference signal resource may comprise different (non-overlapped) REs. The first sidelink reference signal resource and the second sidelink reference signal resource are in the one occasion.

In response to the comb-N structure/design, total number of available/associated frequency/comb offsets are N. The available/associated frequency/comb offsets may be integers 0 to (N−1). The concept B is that one or more frequency/comb offsets, among the available/associated frequency/comb offsets, are allowed to utilize for the set of sidelink reference signal resources in the one occasion. Other frequency/comb offsets except the one or more frequency/comb offsets are prevented/precluded/excluded from utilizing for the set of sidelink reference signal resources in the one occasion. Thus, the set of sidelink reference signal resources can be separated with more REs, which may mitigate the interference issue. For the instance shown in FIG. 8A, there are two SL PRS occasions within one slot. In the former SL PRS occasion, given comb-4 structure/design, 4 SL PRS resources with index 1˜4 may be derived or determined based on available/associated frequency/comb offset 0˜3. For example, SL PRS resource with index 4 is derived or determined based on frequency offset=0. SL PRS resource with index 2 is derived or determined based on frequency offset=2. When/if the one or more frequency/comb offsets is 0 and 2, SL PRS resource with index 4 and 2 are allowed to utilize for SL PRS transmission, and SL PRS resource with index 3 and 1 are prevented/precluded/excluded from utilizing for SL PRS transmission. When/if the one or more frequency/comb offsets is 1 and 3, SL PRS resource with index 3 and 1 are allowed to utilize for SL PRS transmission, and SL PRS resource with index 4 and 2 are prevented/precluded/excluded from utilizing for SL PRS transmission.

Preferably in certain embodiments, the one or more frequency/comb offsets are among/within the available/associated frequency/comb offsets 0 to (N−1). Preferably in certain embodiments, for different N (e.g., different comb-N structure/design is applied/utilized), the one or more frequency/comb offsets may be different.

In one embodiment, the one or more frequency/comb offsets may be specified or configured. Preferably in certain embodiments, the one or more frequency/comb offsets may be configured in the configuration of the sidelink resource pool for sidelink reference signal or via UE configuration for sidelink reference signal.

In one embodiment, the one or more frequency/comb offsets may be determined/derived based on Channel Busy Rate (CBR). The CBR may be determined/derived (by the UE) for the sidelink resource pool. Preferably in certain embodiments, the CBR may be determined/derived based on all sidelink reference signal resources associated with all the available/associated frequency/comb offsets (at least in frequency domain) in the sidelink resource pool. Preferably and/or alternatively, the CBR may be determined/derived based on all sidelink reference signal resources associated with the (currently utilized) one or more frequency/comb offsets (at least in frequency domain) in the sidelink resource pool. Preferably in certain embodiments, the CBR value may be within [0, 1]. Preferably in certain embodiments, the CBR value may be any of 0, 0.01, 0.02, 0.99, or 1. Preferably in certain embodiments, the mapping/association between the one or more frequency/comb offsets and the CBR may be configured, e.g., configured in a configuration of the sidelink resource pool. One possible motivation is that when CBR is higher (e.g., the channel becomes congested), more frequency/comb offsets may be utilized/configured as the one or more frequency/comb offsets. Then, in this case, more sidelink reference signal resources can be utilized with higher interference.

For an instance, when CBR is smaller than a first value, a first one or more frequency/comb offsets (e.g., 0, 4 for N=8) may be determined/derived, e.g., based on the configuration of the sidelink resource pool. When CBR is larger than a first value (and/or smaller than a second value), a second one or more frequency/comb offsets (e.g., 0, 2, 4, 6 for N=8) may be determined/derived, e.g., based on the configuration of the sidelink resource pool. The second value may be larger than the first value. The second one or more frequency/comb offsets may comprise at least the first one or more frequency/comb offsets.

For an instance, when CBR is within a first range, a first one or more frequency/comb offsets (e.g., 0, 4 for N=8) may be determined/derived, e.g., based on the configuration of the sidelink resource pool. When CBR is within a second range, a second one or more frequency/comb offsets (e.g., 0, 2, 4, 6 for N=8) may be determined/derived, e.g., based on the configuration of the sidelink resource pool. The second range may comprise larger values than the first range. The second one or more frequency/comb offsets may comprise at least the first one or more frequency/comb offsets.

In one embodiment, the one or more frequency/comb offsets may be determined/derived based on mobility. Preferably in certain embodiments, the mobility may be/mean the UE mobility. Preferably and/or alternatively, the mobility may be/mean (relative) mobility to another UE/destination. Preferably in certain embodiments, the mobility may be/mean mobility of another UE/destination. Preferably in certain embodiments, the UE may perform sidelink reference signal transmission to at least the another UE/destination. Preferably in certain embodiments, the mapping/association between the one or more frequency/comb offsets and the mobility may be configured, e.g., configured in a configuration of the sidelink resource pool or in UE configuration for sidelink reference signal. One possible motivation is that when mobility is faster (e.g., speed/velocity becomes faster), less frequency/comb offsets may be utilized/configured as the one or more frequency/comb offsets. Then, in this case, interference due to Doppler frequency shift may be mitigated.

In one embodiment, the one or more frequency/comb offsets may be determined/derived based on (expected) Doppler frequency shift. Preferably in certain embodiments, the mapping/association between the one or more frequency/comb offsets and the (expected) Doppler frequency shift may be configured, e.g., configured in a configuration of the sidelink resource pool or in UE configuration for sidelink reference signal. One possible motivation is that when the (expected) Doppler frequency shift is larger (e.g., when mobility/speed/velocity becomes faster), less frequency/comb offsets may be utilized/configured as the one or more frequency/comb offsets. Then, in this case, interference due to Doppler frequency shift may be mitigated.

In one embodiment, when the UE performs sensing-based resource selection for sidelink reference signal, the UE may determine a plurality of candidate resources for sidelink reference signal in a sidelink resource pool. The UE may exclude one or more candidate resources, among/from the plurality of candidate resources, based on the sensing result. Preferably in certain embodiments, the UE may exclude one or more candidate resources based on received SCI(s) from another/other UE(s). The UE may determine/derive a set of valid/identified candidate resources, from some/all (remaining) candidate resource after the exclusion. The UE may determine/select one or more resources from the set of valid/identified candidate resources. The UE may determine/select one or more resources satisfying that the one or more resources are separated with enough REs from the excluded one or more candidate resources (when/if in the same occasion). Preferably in certain embodiments, the one or more frequency/comb offsets are determined/derived satisfying that the determined/selected one or more resources are separated with enough REs from the excluded one or more candidate resources (when/if in the same occasion). Preferably in certain embodiments, the enough REs may be determined/derived based on the mobility, (expected) Doppler frequency shift, or by UE implementation. The UE may perform one or more sidelink reference signal transmissions on the one or more resources. Preferably in certain embodiments, the one or more resources may be in different TTIs/occasions for sidelink reference signal.

Preferably in certain embodiments, one slot in the sidelink resource pool may comprise one or more occasions for sidelink reference signal. Preferably in certain embodiments, one occasion for sidelink reference signal may comprise a number M of consecutive symbols in time domain. The number M of consecutive symbols for one occasion may be within one slot of the sidelink resource pool. The number M may be specified, indicated, or configured (e.g., configured in the configuration of the sidelink resource pool for sidelink reference signal or via UE configuration for sidelink reference signal). Preferably in certain embodiments, when the sidelink reference signal applies/utilizes comb-N structure/design, the number M may be smaller than or equal to the value N. Preferably in certain embodiments, the one or more occasions for sidelink reference signal in the same one slot may comprise same (e.g., the instance shown in FIG. 8A) or different (e.g., the instance shown in FIG. 8B) number M of consecutive symbols in time domain. Preferably in certain embodiments, a first slot in the sidelink resource pool may comprise first one or more occasions for sidelink reference signal, and a second slot in the sidelink resource pool may comprise second one or more occasions for sidelink reference signal. The first one or more occasions for sidelink reference signal and the second one or more occasions for sidelink reference signal may comprise same or different symbol distribution in time domain. The number of the first one or more occasions for sidelink reference signal and the number of the second one or more occasions for sidelink reference signal may be same or different.

The following concepts, methods, alternatives, and embodiments can be utilized with, in whole or in part, the concepts, methods, alternatives, and embodiments above and herein.

Any of the above and herein methods, alternatives, teachings, concepts, and embodiments may be combined or applied simultaneously.

Preferably in certain embodiments, the sidelink reference signal may be sidelink positioning reference signal (SL PRS).

Preferably in certain embodiments, the sidelink reference signal may be applied/utilized for (absolute and/or relative) positioning and/or ranging.

Preferably in certain embodiments, the sidelink reference signal may be applied/utilized for any of time-based positioning/ranging methods and/or angle-based positioning/ranging methods. Preferably in certain embodiments, the sidelink reference signal may be applied/utilized for any of TDoA, RTT-based positioning/ranging, AoA, AoD, or carrier phase measurement based positioning.

Preferably in certain embodiments, the sidelink reference signal may be SL beam management RS. Preferably in certain embodiments, the sidelink reference signal may be SL Channel State Information Reference Signal (CSI-RS) (for beam management), which is not combined within a PSSCH (bandwidth) in frequency domain. Preferably in certain embodiments, the sidelink reference signal may require large bandwidth. Preferably in certain embodiments, the sidelink reference signal may be utilized for (High-Resolution) localization, sensing, or imaging. Preferably in certain embodiments, the sidelink reference signal may be utilized for beam management (e.g., in FR2).

Preferably in certain embodiments, any of the above concepts, methods, alternatives, and embodiments for sidelink reference signal may be applied for another/other reference signal (e.g., reference signal designed/introduced in future 5G or 6G or etc.).

Preferably in certain embodiments, any of the above concepts, methods, alternatives, and embodiments for sidelink reference signal may be applied for SL CSI-RS (for beam management).

Preferably in certain embodiments, any of the above concepts, methods, alternatives, and embodiments for sidelink reference signal may be applied for reference signal for (High-Resolution) localization (e.g., reference signal designed/introduced in future 5G or 6G or etc.).

Preferably in certain embodiments, any of the above concepts, methods, alternatives, and embodiments for sidelink reference signal may be applied for reference signal for (High-Resolution) sensing (e.g., reference signal designed/introduced in future 5G or 6G or etc.).

Preferably in certain embodiments, any of the above concepts, methods, alternatives, and embodiments for sidelink reference signal may be applied for reference signal for (High-resolution) imaging (e.g., reference signal designed/introduced in future 5G or 6G or etc.).

Preferably in certain embodiments, the candidate occasion may be/mean time-domain resource (pattern unit) for sidelink reference signal. Preferably in certain embodiments, the candidate occasion may be/mean a number of symbols (e.g., M) for (a time resource pattern of) sidelink reference signal.

Preferably in certain embodiments, the sidelink resource pool for sidelink reference signal may be a sidelink resource pool enabled/configured/supported for sidelink reference signal transmission/reception. Preferably in certain embodiments, the sidelink resource pool for sidelink reference signal may not comprise resources of the sidelink data transmission. The sidelink resource pool is a dedicated resource pool for sidelink reference signal.

Preferably in certain embodiments, the sidelink resource pool for sidelink reference signal may be a sidelink resource pool enabled/configured/supported for both sidelink data transmission/reception and sidelink reference signal transmission/reception. Preferably in certain embodiments, the sidelink resource pool for sidelink reference signal may comprise resources of the sidelink data transmission and resources of the sidelink reference signal. Preferably in certain embodiments, the sidelink resource pool for sidelink reference signal may be a shared sidelink resource pool for both sidelink data transmission and sidelink reference signal.

Preferably in certain embodiments, the sidelink data transmission may be PSSCH.

Preferably in certain embodiments, the sidelink reference signal may be any one of SL PRS or SL beam management RS. Preferably in certain embodiments, the sidelink reference signal may be SL CSI-RS (for beam management), which is not combined within a PSSCH (bandwidth) in frequency domain. Preferably in certain embodiments, the sidelink reference signal may require large bandwidth. Preferably in certain embodiments, the sidelink reference signal may be utilized for (High-Resolution) localization, sensing, or imaging. Preferably in certain embodiments, the sidelink reference signal may be utilized for beam management (e.g., in FR2). Preferably in certain embodiments, bandwidth of a sidelink reference signal may comprise part of resource blocks of the sidelink resource pool for sidelink reference signal. Preferably and/or alternatively, bandwidth of a sidelink reference signal may comprise all resource blocks of the sidelink resource pool for sidelink reference signal.

Preferably in certain embodiments, one symbol between SCI/PSCCH occasion and (next/closest/following) SL PRS occasion may be utilized for AGC. Alternatively, there may be no AGC symbol between SCI/PSCCH occasion and (next/closest/following) SL PRS occasion.

Preferably in certain embodiments, one symbol between two (adjacent/neighboring) SL PRS occasions may be utilized for AGC. Preferably in certain embodiments, two symbols between two (adjacent/neighboring) SL PRS occasions may be utilized for Gap/TX-RX_Switch and AGC (respectively). Alternatively, there may be no AGC/Gap/TX-RX_Switch symbol between two (adjacent/neighboring) SL PRS occasions.

Preferably in certain embodiments, the first/initial symbol of one slot or one scheduling/allocation time unit may be utilized for AGC. Preferably in certain embodiments, the last symbol of one slot or one scheduling/allocation time unit may be utilized as gap symbol for possible TX-RX switch.

Preferably in certain embodiments, figures in the present application are just example instances. Distribution of AGC, SCI/PSCCH, SL PRS, Gap, TX-RX switch may be different, depending on future design and/or resource pool configuration.

Preferably in certain embodiments, the SCI/PSCCH associated with SL PRS may include/comprise information for scheduling/indicating/allocating SL PRS resource. Preferably in certain embodiments, the SCI/PSCCH in the resource pool for SL PRS may not comprise information for PSSCH/PSFCH. Preferably in certain embodiments, the SCI/PSCCH in the resource pool for SL PRS may be different from another SCI/PSCCH in a resource pool with sidelink communication (i.e., PSSCH and/or PSFCH). Preferably in certain embodiments, the SCI/PSCCH associated with SL PRS may be different from another SCI/PSCCH associated with PSSCH and/or PSFCH.

Preferably in certain embodiments, sidelink control information for PSSCH may be transmitted/delivered via 1st stage SCI and 2nd stage SCI. Preferably in certain embodiments, the sidelink control information for PSSCH may be delivered at least in PSCCH. Preferably in certain embodiments, the sidelink control information for PSSCH may comprise 1st stage SCI. Preferably in certain embodiments, the 1st stage SCI may be transmitted via PSCCH. Preferably in certain embodiments, the sidelink control information for PSSCH may comprise 2nd stage SCI. Preferably in certain embodiments, the 2nd stage SCI may be transmitted via multiplexed with PSSCH. Preferably in certain embodiments, the SCI format 1 or SCI format 1-X is 1st stage SCI. Preferably in certain embodiments, the SCI format 2-A or 2-B or 2-C or 2-X is a 2nd stage SCI.

Preferably in certain embodiments, for transmitting PSSCH in a slot or sub-slot/subslot, the TX UE needs to transmit SCI in the slot or the sub-slot for scheduling the PSSCH.

Preferably in certain embodiments, the resource pool for SL PRS may be a dedicated resource pool for SL PRS. Preferably in certain embodiments, the resource pool for SL PRS may be a dedicated resource pool for sidelink reference signal and/or sidelink control information.

Preferably in certain embodiments, the resource pool for SL PRS may not be a resource pool with sidelink communication (i.e., PSCCH/PSSCH and/or PSFCH). Alternatively, the resource pool for SL PRS may be a shared resource pool with sidelink communication. The resource pool for SL PRS may comprise PSSCH and/or PSFCH resources.

Preferably in certain embodiments, the slot may mean a sidelink slot. Preferably in certain embodiments, the slot may be represented/replaced as a TTI.

Preferably in certain embodiments, the sidelink slot may mean slot for sidelink. Preferably in certain embodiments, a TTI may be a subframe (for sidelink) or slot (for sidelink) or sub-slot (for sidelink). Preferably in certain embodiments, a TTI comprises multiple symbols, e.g. 12 or 14 symbols. Preferably in certain embodiments, a TTI may be a slot (fully/partially) comprising sidelink symbols. Preferably in certain embodiments, a TTI may mean a transmission time interval for a sidelink (data) transmission. Preferably in certain embodiments, a sidelink slot or a slot for sidelink may contain all OFDM symbols available for sidelink transmission. Preferably in certain embodiments, a sidelink slot or a slot for sidelink may contain a consecutive number of symbols available for sidelink transmission. Preferably in certain embodiments, a sidelink slot or a slot for sidelink means that a slot is included/comprised in a sidelink resource pool.

Preferably in certain embodiments, the symbol may mean a symbol indicated/configured for sidelink.

Preferably in certain embodiments, the slot may mean/comprise sidelink slot associated with the (sidelink) resource pool. Preferably in certain embodiments, the slot may not mean/comprise a sidelink slot associated with another/other (sidelink) resource pool.

Preferably in certain embodiments, the contiguous/consecutive slots may mean contiguous sidelink slots in/for the (sidelink) resource pool.

Preferably in certain embodiments, the contiguous/consecutive slots may or may not be contiguous/consecutive in physical slots. It means that the contiguous/consecutive slots in the sidelink resource pool may be not contiguous/consecutive from the aspect of physical slot. Preferably in certain embodiments, the contiguous/consecutive slots may or may not be contiguous/consecutive in sidelink slots in/for a sidelink BWP or a sidelink carrier/cell. It means that the contiguous/consecutive slots in the (sidelink) resource pool may be not contiguous/consecutive from the aspect of sidelink slots in a sidelink BWP or a sidelink carrier/cell. Preferably in certain embodiments, there may be one or more (sidelink) resource pools in a sidelink BWP or a sidelink carrier/cell.

Preferably in certain embodiments, a sub-channel is a unit for sidelink resource allocation/scheduling (for PSSCH). Preferably in certain embodiments, a sub-channel may comprise multiple contiguous PRBs in frequency domain. Preferably in certain embodiments, the number of PRBs for each sub-channel may be (pre-)configured for a sidelink resource pool. Preferably in certain embodiments, a sidelink resource pool (pre-)configuration may indicate/configure the number of PRBs for each sub-channel. Preferably in certain embodiments, the number of PRBs for each sub-channel may be any of 10, 12, 15, 20, 25, 50, 75, 100. Preferably in certain embodiments, a sub-channel may be represented as a unit for sidelink resource allocation/scheduling. Preferably in certain embodiments, a sub-channel may mean a set of consecutive PRBs in frequency domain. Preferably in certain embodiments, a sub-channel may mean a set of consecutive resource elements in frequency domain.

Preferably in certain embodiments, the first UE may have/maintain/establish multiple sidelink links/connections on PC5 interface. For different sidelink links/connections, the first UE may perform sidelink transmission/reception to/from different paired UE(s).

Preferably in certain embodiments, the first UE may have/maintain/establish a first sidelink link/connection and a second sidelink link/connection. The paired UE of the first sidelink link/connection may be different from the paired UE of the second sidelink link/connection. Preferably in certain embodiments, the sidelink logical channel(s) associated with (the paired UE of) the first sidelink link/connection are separate/independent from the sidelink logical channel(s) associated with (the paired UE of) the second sidelink link/connection.

Preferably in certain embodiments, the UE may be/mean/comprise/replace a device.

Preferably in certain embodiments, the sidelink transmission/reception may be UE-to-UE transmission/reception. Preferably in certain embodiments, the sidelink transmission/reception may be device-to-device transmission/reception. Preferably in certain embodiments, the sidelink transmission/reception may be Vehicle-to-Everything (V2X) transmission/reception. Preferably in certain embodiments, the sidelink transmission/reception may be Pedestrian-to-Everything (P2X) transmission/reception. Preferably in certain embodiments, the sidelink transmission/reception may be on PC5 interface.

Preferably in certain embodiments, the PC5 interface may be a wireless interface for communication between device and device. Preferably in certain embodiments, the PC5 interface may be a wireless interface for communication between devices. Preferably in certain embodiments, the PC5 interface may be a wireless interface for communication between UEs. Preferably in certain embodiments, the PC5 interface may be a wireless interface for V2X or P2X communication. Preferably in certain embodiments, the Uu interface may be a wireless interface for communication between network node and device. Preferably in certain embodiments, the Uu interface may be a wireless interface for communication between network node and UE.

Preferably in certain embodiments, the first UE may be a first device. Preferably in certain embodiments, the first UE may be a vehicle UE. Preferably in certain embodiments, the first UE may be a V2X UE.

Preferably in certain embodiments, the second UE may be a second device. Preferably in certain embodiments, the second UE may be a vehicle UE. Preferably in certain embodiments, the second device may be a V2X UE.

Preferably in certain embodiments, the first UE and the second device are different devices.

Preferably in certain embodiments, frequency offset could be replaced by RE offset or comb-offset (e.g., 0˜N−1).

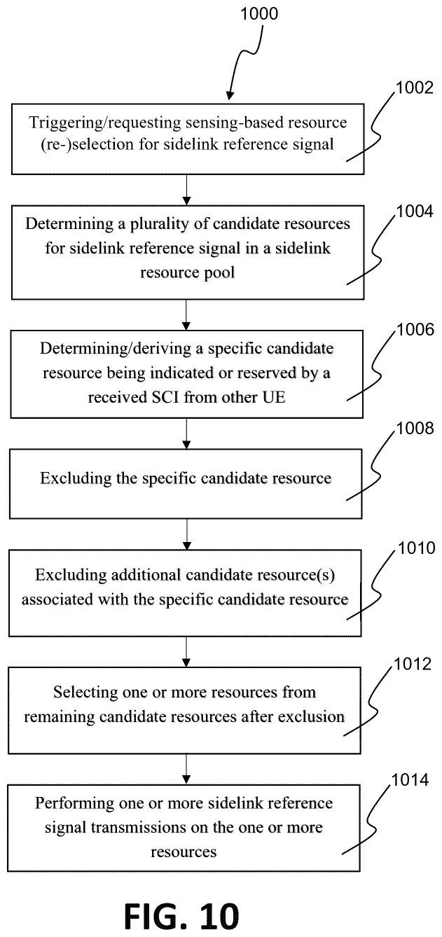

Referring to FIG. 10, with this and other concepts, systems, and methods of the present invention, a method 1000 for a first device in a wireless communication system comprises triggering/requesting sensing-based resource (re-)selection for sidelink reference signal (step 1002), determining a plurality of candidate resources for sidelink reference signal in a sidelink resource pool (step 1004), determining/deriving a specific candidate resource being indicated or reserved by a received SCI from other UE (step 1006), excluding the specific candidate resource (step 1008), excluding additional candidate resource(s) associated with the specific candidate resource (step 1010), selecting one or more resources from remaining candidate resources after exclusion (step 1012), and performing one or more sidelink reference signal transmissions on the one or more resources (step 1014).

In various embodiments, the additional candidate resource(s) are in the same occasion as the specific candidate resource; and/or the additional candidate resource(s) and the specific candidate resource comprise the same PRB(s) or sub-channel(s) in frequency domain; and/or the additional candidate resource(s) and the specific candidate resource comprises different (non-overlapped) REs, and/or the additional candidate resource(s) comprises different REs, which are adjacent/neighbored/close to the specific candidate resource.

Referring back to FIGS. 3 and 4, in one or more embodiments from the perspective of a first device, the device 300 includes a program code 312 stored in memory 310 of the transmitter. The CPU 308 could execute program code 312 to: (i) trigger/request sensing-based resource (re-)selection for sidelink reference signal; (ii) determine a plurality of candidate resources for sidelink reference signal in a sidelink resource pool; (iii) determine/derive a specific candidate resource being indicated or reserved by a received SCI from other UE; (iv) exclude the specific candidate resource; (v) exclude additional candidate resource(s) associated with the specific candidate resource; (vi) select one or more resources from remaining candidate resources after exclusion; and (vii) perform one or more sidelink reference signal transmissions on the one or more resources. Moreover, the CPU 308 can execute the program code 312 to perform all of the described actions, steps, and methods described above, below, or otherwise herein.

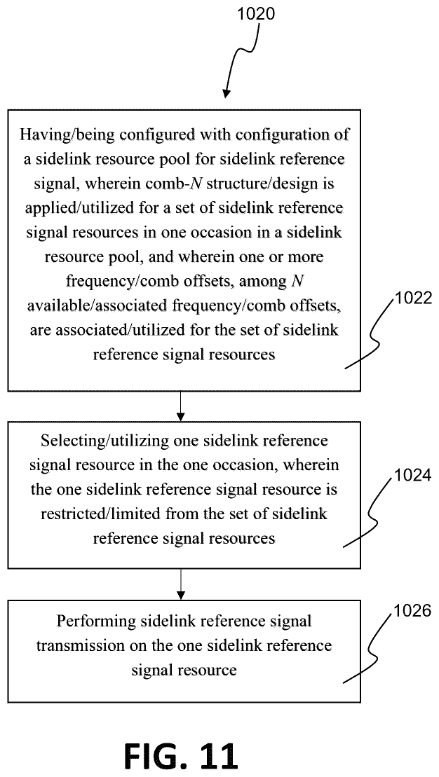

Referring to FIG. 11, with this and other concepts, systems, and methods of the present invention, a method 1020 for a first device in a wireless communication system comprises having/being configured with configuration of a sidelink resource pool for sidelink reference signal, wherein comb-N structure/design is applied/utilized for a set of sidelink reference signal resources in one occasion in a sidelink resource pool, and wherein one or more frequency/comb offsets, among N available/associated frequency/comb offsets, are associated/utilized for the set of sidelink reference signal resources (step 1022), selecting/utilizing one sidelink reference signal resource in the one occasion, wherein the one sidelink reference signal resource is restricted/limited from the set of sidelink reference signal resources (step 1024), and performing sidelink reference signal transmission on the one sidelink reference signal resource (step 1026).

In various embodiments, the one or more frequency/comb offsets are specified or configured, e.g., in configuration of the sidelink resource pool for sidelink reference signal or via device configuration for sidelink reference signal; and/or the one or more frequency/comb offsets are determined/derived based CBR determined/derived (by the UE) for the sidelink resource pool; and/or the one or more frequency/comb offsets are determined/derived based on mobility or (expected) Doppler frequency shift.

In various embodiments, the first device performs sensing-based resource selection for sidelink reference signal, the first device excludes one or more candidate resources based on the sensing result, the first device determines/derives a set of valid/identified candidate resources, from some/all (remaining) candidate resource after the exclusion; and/or the first device determines/selects one or more resources, from the set of valid/identified candidate resources, satisfying that the one or more resources are separated with enough REs from the excluded one or more candidate resources (when/if in the same occasion).

Referring back to FIGS. 3 and 4, in one or more embodiments from the perspective of a first device, the device 300 includes a program code 312 stored in memory 310 of the transmitter. The CPU 308 could execute program code 312 to: (i) have/be configured with configuration of a sidelink resource pool for sidelink reference signal, wherein comb-N structure/design is applied/utilized for a set of sidelink reference signal resources in one occasion in a sidelink resource pool, and wherein one or more frequency/comb offsets, among N available/associated frequency/comb offsets, are associated/utilized for the set of sidelink reference signal resources; (ii) select/utilize one sidelink reference signal resource in the one occasion, wherein the one sidelink reference signal resource is restricted/limited from the set of sidelink reference signal resources; and (iii) perform sidelink reference signal transmission on the one sidelink reference signal resource. Moreover, the CPU 308 can execute the program code 312 to perform all of the described actions, steps, and methods described above, below, or otherwise herein.

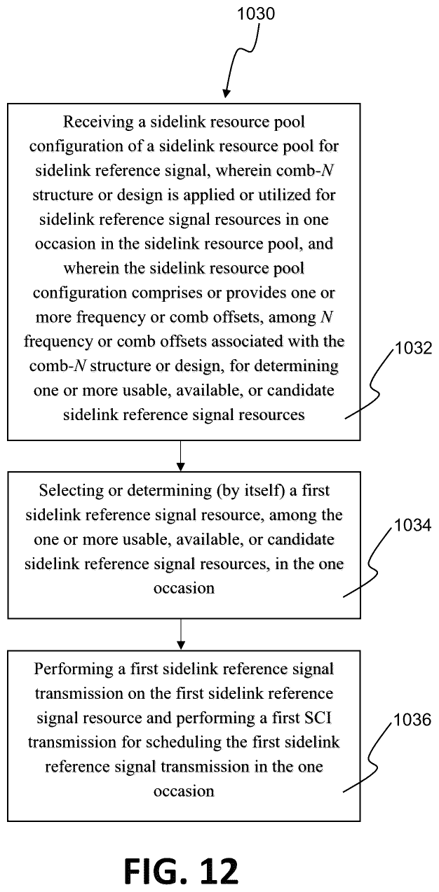

Referring to FIG. 12, with this and other concepts, systems, and methods of the present invention, a method 1030 for a first device in a wireless communication system comprises receiving a sidelink resource pool configuration of a sidelink resource pool for sidelink reference signal, wherein comb-N structure or design is applied or utilized for sidelink reference signal resources in one occasion in the sidelink resource pool, and wherein the sidelink resource pool configuration comprises or provides one or more frequency or comb offsets, among N frequency or comb offsets associated with the comb-N structure or design, for determining one or more usable, available, or candidate sidelink reference signal resources (step 1032), selecting or determining (by itself) a first sidelink reference signal resource, among the one or more usable, available, or candidate sidelink reference signal resources, in the one occasion (step 1034), and performing a first sidelink reference signal transmission on the first sidelink reference signal resource and performing a first SCI transmission for scheduling the first sidelink reference signal transmission in the one occasion (step 1036).

In various embodiments, in the one occasion in the sidelink resource pool, other frequency or comb offsets other than the one or more frequency or comb offsets, among the N frequency or comb offsets associated with the comb-N structure or design, are precluded or excluded from utilization for sidelink reference signal transmissions; and/or in the one occasion in the sidelink resource pool, only the one or more frequency or comb offsets, among N frequency or comb offsets associated with the comb-N structure or design, are usable or available for sidelink reference signal transmissions; and/or in the one occasion in the sidelink resource pool, other sidelink reference signal resources other than the one or more usable, available, or candidate sidelink reference signal resources are precluded or excluded from utilization for sidelink reference signal transmissions; and/or in the one occasion in the sidelink resource pool, only the one or more usable, available, or candidate sidelink reference signal resources are usable or available for sidelink reference signal transmissions.

In various embodiments, the one or more frequency or comb offsets are part of the N frequency or comb offsets associated with the comb-N structure or design; a number of the one or more frequency or comb offsets are smaller than value N; and/or a number of the one or more usable, available, or candidate sidelink reference signal resources are smaller than the value N.

In various embodiments, the one or more frequency or comb offsets are determined or derived based on CBR of the sidelink resource pool; and/or the one or more usable, available, or candidate sidelink reference signal resources are configured in the sidelink resource pool configuration of the sidelink resource pool for sidelink reference signal.

In various embodiments, each of the one or more usable, available, or candidate sidelink reference signal resources is determined or associated with each of the one or more frequency or comb offsets; and/or the first sidelink reference signal resource is restricted or limited within the one or more usable, available, or candidate sidelink reference signal resources; and/or the first sidelink reference signal resource is determined or associated with a first frequency or comb offset among the one or more frequency or comb offsets; and/or the first frequency or comb offset is associated with a value among 0˜(N−1).

In various embodiments, the N frequency or comb offsets associated with the comb-N structure or design are frequency or comb offsets 0˜(N−1); and/or for one sidelink reference signal resource applying or utilizing the comb-N structure or design, adjacent two REs in the one sidelink reference signal resource in a symbol are separated with (N−1) REs or with a frequency gap of (N−1) REs.

In various embodiments, the first SCI transmission indicates or allocates the first sidelink reference signal transmission in the one occasion.

In various embodiments, the first device performs sensing-based resource selection for sidelink reference signal; and/or the first device determines or initializes a plurality of candidate sidelink reference signal resources as (comprising) the one or more usable, available, or candidate sidelink reference signal resources in the one occasion; and/or the first device excludes one or more candidate sidelink reference signal resources, from the plurality of candidate sidelink reference signal resources, based on the sensing result; and/or the first device receives a second SCI transmission reserving a second sidelink reference signal resource in the one occasion, and the first device excludes the second sidelink reference signal resource from the plurality of candidate sidelink reference signal resources; and/or the first device determines or derives a plurality of valid or identified candidate sidelink reference signal resources after the exclusion; and/or the first device determines or selects the first sidelink reference signal resource from the plurality of valid or identified candidate sidelink reference signal resources.

In various embodiments, the first device receives a sidelink grant from network node; and/or the first device determines the first sidelink reference signal resource based on indication or allocation of the sidelink grant, wherein the first sidelink reference signal resource is restricted or limited within the one or more usable, available, or candidate sidelink reference signal resources.

In various embodiments, the sidelink reference signal is a SL PRS; the sidelink resource pool for sidelink reference signal is a dedicated sidelink resource pool for the SL PRS; and/or one slot in the sidelink resource pool comprises one or more occasions for SL PRS; and/or the one occasion comprises one or more symbols in the one slot.

Referring back to FIGS. 3 and 4, in one or more embodiments from the perspective of a first device, the device 300 includes a program code 312 stored in memory 310 of the transmitter. The CPU 308 could execute program code 312 to: (i) receive a sidelink resource pool configuration of a sidelink resource pool for sidelink reference signal, wherein comb-N structure or design is applied or utilized for sidelink reference signal resources in one occasion in the sidelink resource pool, and wherein the sidelink resource pool configuration comprises or provides one or more frequency or comb offsets, among N frequency or comb offsets associated with the comb-N structure or design, for determining one or more usable, available, or candidate sidelink reference signal resources; (ii) select or determine (by itself) a first sidelink reference signal resource, among the one or more usable, available, or candidate sidelink reference signal resources, in the one occasion; and (iii) perform a first sidelink reference signal transmission on the first sidelink reference signal resource and performing a first SCI transmission for scheduling the first sidelink reference signal transmission in the one occasion. Moreover, the CPU 308 can execute the program code 312 to perform all of the described actions, steps, and methods described above, below, or otherwise herein.

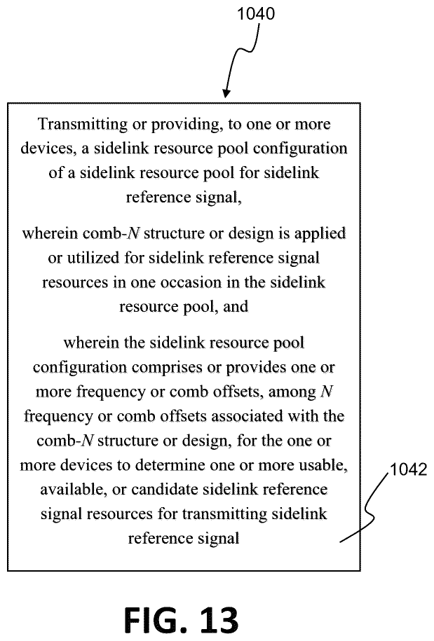

Referring to FIG. 13, with this and other concepts, systems, and methods of the present invention, a method 1040 for a network node in a wireless communication system comprises transmitting or providing, to one or more devices, a sidelink resource pool configuration of a sidelink resource pool for sidelink reference signal, wherein comb-N structure or design is applied or utilized for sidelink reference signal resources in one occasion in the sidelink resource pool, and wherein the sidelink resource pool configuration comprises or provides one or more frequency or comb offsets, among N frequency or comb offsets associated with the comb-N structure or design, for the one or more devices to determine one or more usable, available, or candidate sidelink reference signal resources for transmitting sidelink reference signal (step 1042).

In various embodiments, in the one occasion in the sidelink resource pool, other frequency or comb offsets other than the one or more frequency or comb offsets, among the N frequency or comb offsets associated with the comb-N structure or design, are precluded or excluded from utilization for sidelink reference signal transmissions; and/or in the one occasion in the sidelink resource pool, only the one or more frequency or comb offsets, among N frequency or comb offsets associated with the comb-N structure or design, are usable or available for sidelink reference signal transmissions; and/or in the one occasion in the sidelink resource pool, other sidelink reference signal resources, other than the one or more usable, available, or candidate sidelink reference signal resources, are precluded or excluded from utilization for sidelink reference signal transmissions; and/or in the one occasion in the sidelink resource pool, only the one or more usable, available, or candidate sidelink reference signal resources are usable or available for sidelink reference signal transmissions.

In various embodiments, the one or more frequency or comb offsets are part of the N frequency or comb offsets associated with the comb-N structure or design; a number of the one or more frequency or comb offsets are smaller than value N; and/or a number of the one or more usable, available, or candidate sidelink reference signal resources are smaller than the value N.

In various embodiments, the network node transmits or provides association between the one or more frequency or comb offsets and a CBR of the sidelink resource pool; and/or a first device, among the one or more devices, determines or derives the one or more frequency or comb offsets based on the CBR of the sidelink resource pool; and/or the one or more usable, available, or candidate sidelink reference signal resources are configured in the sidelink resource pool configuration of the sidelink resource pool for sidelink reference signal.

In various embodiments, the N frequency or comb offsets associated with the comb-N structure or design are frequency or comb offsets 0˜(N−1); and/or for one sidelink reference signal resource applying or utilizing the comb-N structure or design, adjacent two REs in the one sidelink reference signal resource in a symbol are separated with (N−1) REs or with frequency gap of (N−1) REs; and/or each of the one or more usable, available, or candidate sidelink reference signal resources is determined or associated with each of the one or more frequency or comb offsets.

In various embodiments, a first device, among the one or more devices, selects or determines a first sidelink reference signal resource in the sidelink resource pool in the one occasion, wherein the first sidelink reference signal resource is restricted or limited within the one or more usable, available, or candidate sidelink reference signal resources; and/or the first device performs a first sidelink reference signal transmission on the first sidelink reference signal resource and performs a first SCI transmission for scheduling the first sidelink reference signal transmission in the one occasion; and/or the first sidelink reference signal resource is determined or associated with a first frequency or comb offset among the one or more frequency or comb offsets; and/or the first frequency or comb offset is associated with a value among 0˜(N−1).

In various embodiments, the first SCI transmission indicates or allocates the first sidelink reference signal transmission in the one occasion.

In various embodiments, the first device performs sensing-based resource selection for sidelink reference signal; and/or the first device determines or initializes a plurality of candidate sidelink reference signal resources as (comprising) the one or more usable, available, or candidate sidelink reference signal resources in the one occasion; and/or the first device excludes one or more candidate sidelink reference signal resources, from the plurality of candidate sidelink reference signal resources, based on the sensing result; and/or the first device receives a second SCI transmission reserving a second sidelink reference signal resource in the one occasion, the first device excludes the second sidelink reference signal resource from the plurality of candidate sidelink reference signal resources; and/or the first device determines or derives a plurality of valid, identified, or candidate sidelink reference signal resources after the exclusion; and/or the first device determines or selects the first sidelink reference signal resource from the plurality of valid or identified candidate sidelink reference signal resources.

In various embodiments, the network node transmits a sidelink grant to a first device among the one or more devices, wherein the sidelink grant indicates or allocates a first sidelink reference signal resource restricted or limited within the one or more usable, available, candidate sidelink reference signal resources.

In various embodiments, the sidelink reference signal is a SL PRS; and/or the sidelink resource pool for sidelink reference signal is a dedicated sidelink resource pool for SL PRS; and/or one slot in the sidelink resource pool comprises one or more occasions for SL PRS; and/or the one occasion comprises one or more symbols in the one slot.

Referring back to FIGS. 3 and 4, in one or more embodiments from the perspective of a network node, the device 300 includes a program code 312 stored in memory 310 of the transmitter. The CPU 308 could execute program code 312 to: (i) transmit or provide, to one or more devices, a sidelink resource pool configuration of a sidelink resource pool for sidelink reference signal, wherein comb-N structure or design is applied or utilized for sidelink reference signal resources in one occasion in the sidelink resource pool, and wherein the sidelink resource pool configuration comprises or provides one or more frequency or comb offsets, among N frequency or comb offsets associated with the comb-N structure or design, for the one or more devices to determine one or more usable, available, or candidate sidelink reference signal resources for transmitting sidelink reference signal. Moreover, the CPU 308 can execute the program code 312 to perform all of the described actions, steps, and methods described above, below, or otherwise herein.

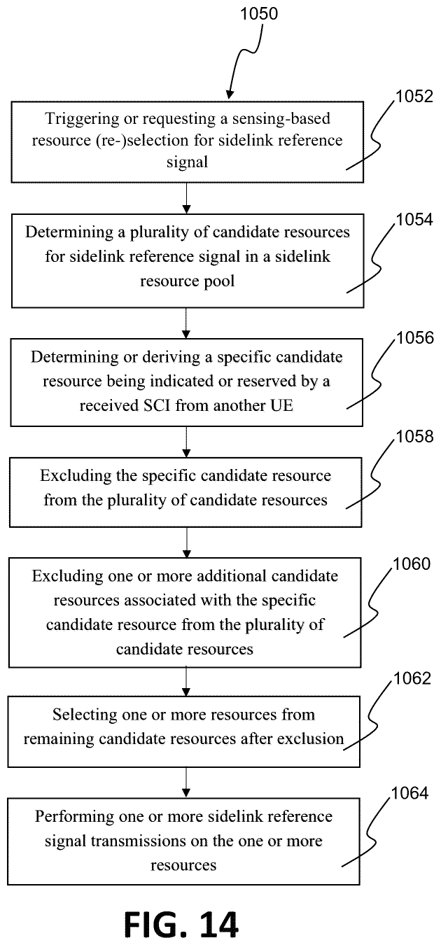

Referring to FIG. 14, with this and other concepts, systems, and methods of the present invention, a method 1050 for a first device in a wireless communication system comprises triggering or requesting a sensing-based resource (re-)selection for sidelink reference signal (step 1052), determining a plurality of candidate resources for sidelink reference signal in a sidelink resource pool (step 1054), determining or deriving a specific candidate resource being indicated or reserved by a received SCI from another UE (step 1056), excluding the specific candidate resource from the plurality of candidate resources (step 1058), excluding one or more additional candidate resources associated with the specific candidate resource from the plurality of candidate resources (step 1060), selecting one or more resources from remaining candidate resources after exclusion (step 1062), and performing one or more sidelink reference signal transmissions on the one or more resources (step 1064).

In various embodiments, the one or more additional candidate resources are in a same occasion as the specific candidate resource; and/or the one or more additional candidate resources and the specific candidate resource comprise one or more same PRBs or sub-channels in frequency domain; and/or the one or more additional candidate resources and the specific candidate resource comprise different (non-overlapped) REs; and/or the one or more additional candidate resources and the specific candidate resource apply a same comb-N structure or design with different frequency or comb offsets; and/or the one or more additional candidate resources comprise different REs which are at least adjacent, neighbored, or close to the specific candidate resource.

In various embodiments, the sidelink reference signal is a SL PRS; the sidelink resource pool for sidelink reference signal is a dedicated sidelink resource pool for the SL PRS; one slot in the sidelink resource pool comprises one or more occasions for SL PRS; and/or one occasion comprises one or more symbols in the one slot.

Referring back to FIGS. 3 and 4, in one or more embodiments from the perspective of a first device, the device 300 includes a program code 312 stored in memory 310 of the transmitter. The CPU 308 could execute program code 312 to: (i) trigger or request a sensing-based resource (re-)selection for sidelink reference signal; (ii) determine a plurality of candidate resources for sidelink reference signal in a sidelink resource pool; (iii) determine or derive a specific candidate resource being indicated or reserved by a received SCI from another UE; (iv) exclude the specific candidate resource from the plurality of candidate resources; (v) exclude one or more additional candidate resources associated with the specific candidate resource from the plurality of candidate resources; (vi) select one or more resources from remaining candidate resources after exclusion; and (vii) perform one or more sidelink reference signal transmissions on the one or more resources. Moreover, the CPU 308 can execute the program code 312 to perform all of the described actions, steps, and methods described above, below, or otherwise herein.

Any combination of the above concepts or teachings can be jointly combined or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a first device, comprising:
receiving a sidelink resource pool configuration of a sidelink resource pool for sidelink reference signal,
wherein comb-N structure or design is applied or utilized for sidelink reference signal resources in one occasion in the sidelink resource pool, and
wherein the sidelink resource pool configuration comprises or provides one or more frequency or comb offsets, among N frequency or comb offsets associated with the comb-N structure or design, for determining one or more usable, available, or candidate sidelink reference signal resources;
selecting or determining a first sidelink reference signal resource, among the one or more usable, available, or candidate sidelink reference signal resources, in the one occasion; and
performing a first sidelink reference signal transmission on the first sidelink reference signal resource and performing a first Sidelink Control Information (SCI) transmission for scheduling the first sidelink reference signal transmission in the one occasion.

2. The method of claim 1, wherein:
in the one occasion in the sidelink resource pool, other frequency or comb offsets other than the one or more frequency or comb offsets, among the N frequency or comb offsets associated with the comb-N structure or design, are precluded or excluded from utilization for sidelink reference signal transmissions; and/or
in the one occasion in the sidelink resource pool, only the one or more frequency or comb offsets, among N frequency or comb offsets associated with the comb-N structure or design, are usable or available for sidelink reference signal transmissions; and/or
in the one occasion in the sidelink resource pool, other sidelink reference signal resources other than the one or more usable, available, or candidate sidelink reference signal resources are precluded or excluded from utilization for sidelink reference signal transmissions; and/or
in the one occasion in the sidelink resource pool, only the one or more usable, available, or candidate sidelink reference signal resources are usable or available for sidelink reference signal transmissions.

3. The method of claim 1, wherein:
the one or more frequency or comb offsets are part of the N frequency or comb offsets associated with the comb-N structure or design; and/or
a number of the one or more frequency or comb offsets are smaller than value N; and/or
a number of the one or more usable, available, or candidate sidelink reference signal resources are smaller than the value N.

4. The method of claim 1, wherein:
the one or more frequency or comb offsets are determined or derived based on Channel Busy Rate (CBR) of the sidelink resource pool; and/or
the one or more usable, available, or candidate sidelink reference signal resources are configured in the sidelink resource pool configuration of the sidelink resource pool for sidelink reference signal.

5. The method of claim 1, wherein:
each of the one or more usable, available, or candidate sidelink reference signal resources is determined or associated with each of the one or more frequency or comb offsets; and/or
the first sidelink reference signal resource is restricted or limited within the one or more usable, available, or candidate sidelink reference signal resources; and/or
the first sidelink reference signal resource is determined or associated with a first frequency or comb offset among the one or more frequency or comb offsets; and/or
the first frequency or comb offset is associated with a value among 0˜(N−1).

6. The method of claim 1, wherein:
the N frequency or comb offsets associated with the comb-N structure or design are frequency or comb offsets 0˜(N−1); and/or
for one sidelink reference signal resource applying or utilizing the comb-N structure or design, adjacent two Resource Elements (REs) in the one sidelink reference signal resource in a symbol are separated with (N−1) REs or with a frequency gap of (N−1) REs.

7. The method of claim 1, wherein:
the first device performs sensing-based resource selection for sidelink reference signal; and/or
the first device determines or initializes a plurality of candidate sidelink reference signal resources as the one or more usable, available, or candidate sidelink reference signal resources in the one occasion; and/or
the first device excludes one or more candidate sidelink reference signal resources, from the plurality of candidate sidelink reference signal resources, based on the sensing result; and/or
the first device receives a second SCI transmission reserving a second sidelink reference signal resource in the one occasion, and the first device excludes the second sidelink reference signal resource from the plurality of candidate sidelink reference signal resources; and/or
the first device determines or derives a plurality of valid or identified candidate sidelink reference signal resources after the exclusion; and/or
the first device determines or selects the first sidelink reference signal resource from the plurality of valid or identified candidate sidelink reference signal resources.

8. The method of claim 1, wherein:
the first device receives a sidelink grant from a network node; and/or
the first device determines the first sidelink reference signal resource based on indication or allocation of the sidelink grant, wherein the first sidelink reference signal resource is restricted or limited within the one or more usable, available, or candidate sidelink reference signal resources.

9. The method of claim 1, wherein:
the sidelink reference signal is a Sidelink Positioning Reference Signal (SL PRS); and/or
the sidelink resource pool for sidelink reference signal is a dedicated sidelink resource pool for the SL PRS; and/or
one slot in the sidelink resource pool comprises one or more occasions for SL PRS; and/or
the one occasion comprises one or more symbols in the one slot.

10. A method of a network node, comprising:
transmitting or providing, to one or more devices, a sidelink resource pool configuration of a sidelink resource pool for sidelink reference signal,
wherein comb-N structure or design is applied or utilized for sidelink reference signal resources in one occasion in the sidelink resource pool, and
wherein the sidelink resource pool configuration comprises or provides one or more frequency or comb offsets, among N frequency or comb offsets associated with the comb-N structure or design, for the one or more devices to determine one or more usable, available, or candidate sidelink reference signal resources for transmitting sidelink reference signal.

11. The method of claim 10, wherein:
in the one occasion in the sidelink resource pool, other frequency or comb offsets other than the one or more frequency or comb offsets, among the N frequency or comb offsets associated with the comb-N structure or design, are precluded or excluded from utilization for sidelink reference signal transmissions; and/or
in the one occasion in the sidelink resource pool, only the one or more frequency or comb offsets, among N frequency or comb offsets associated with the comb-N structure or design, are usable or available for sidelink reference signal transmissions; and/or
in the one occasion in the sidelink resource pool, other sidelink reference signal resources, other than the one or more usable, available, or candidate sidelink reference signal resources, are precluded or excluded from utilization for sidelink reference signal transmissions; and/or
in the one occasion in the sidelink resource pool, only the one or more usable, available, or candidate sidelink reference signal resources are usable or available for sidelink reference signal transmissions.

12. The method of claim 10, wherein:
the one or more frequency or comb offsets are part of the N frequency or comb offsets associated with the comb-N structure or design; and/or
a number of the one or more frequency or comb offsets are smaller than value N; and/or
a number of the one or more usable, available, or candidate sidelink reference signal resources are smaller than the value N.

13. The method of claim 10, wherein:
the network node transmits or provides association between the one or more frequency or comb offsets and a Channel Busy Rate (CBR) of the sidelink resource pool; and/or
a first device, among the one or more devices, determines or derives the one or more frequency or comb offsets based on the CBR of the sidelink resource pool; and/or
the one or more usable, available, or candidate sidelink reference signal resources are configured in the sidelink resource pool configuration of the sidelink resource pool for sidelink reference signal.

14. The method of claim 10, wherein:
the N frequency or comb offsets associated with the comb-N structure or design are frequency or comb offsets 0˜(N−1); and/or
for one sidelink reference signal resource applying or utilizing the comb-N structure or design, adjacent two Resource Elements (REs) in the one sidelink reference signal resource in a symbol are separated with (N−1) REs or with frequency gap of (N−1) REs; and/or
each of the one or more usable, available, or candidate sidelink reference signal resources is determined or associated with each of the one or more frequency or comb offsets.

15. The method of claim 10, wherein:
a first device, among the one or more devices, selects or determines a first sidelink reference signal resource in the sidelink resource pool in the one occasion, wherein the first sidelink reference signal resource is restricted or limited within the one or more usable, available, or candidate sidelink reference signal resources; and/or
the first device performs a first sidelink reference signal transmission on the first sidelink reference signal resource and performs a first Sidelink Control Information (SCI) transmission for scheduling the first sidelink reference signal transmission in the one occasion; and/or
the first sidelink reference signal resource is determined or associated with a first frequency or comb offset among the one or more frequency or comb offsets; and/or
the first frequency or comb offset is associated with a value among 0˜(N−1).

16. The method of claim 15, wherein:
the first device performs sensing-based resource selection for sidelink reference signal; and/or
the first device determines or initializes a plurality of candidate sidelink reference signal resources as the one or more usable, available, or candidate sidelink reference signal resources in the one occasion; and/or
the first device excludes one or more candidate sidelink reference signal resources, from the plurality of candidate sidelink reference signal resources, based on the sensing result; and/or
the first device receives a second SCI transmission reserving a second sidelink reference signal resource in the one occasion, the first device excludes the second sidelink reference signal resource from the plurality of candidate sidelink reference signal resources; and/or
the first device determines or derives a plurality of valid, identified, or candidate sidelink reference signal resources after the exclusion; and/or
the first device determines or selects the first sidelink reference signal resource from the plurality of valid or identified candidate sidelink reference signal resources.

17. The method of claim 10, wherein the network node transmits a sidelink grant to a first device among the one or more devices, wherein the sidelink grant indicates or allocates a first sidelink reference signal resource restricted or limited within the one or more usable, available, candidate sidelink reference signal resources.

18. The method of claim 10, wherein:
the sidelink reference signal is a Sidelink Positioning Reference Signal (SL PRS); and/or
the sidelink resource pool for sidelink reference signal is a dedicated sidelink resource pool for SL PRS; and/or
one slot in the sidelink resource pool comprises one or more occasions for SL PRS; and/or
the one occasion comprises one or more symbols in the one slot.

19. A method of a first device, comprising:
triggering or requesting a sensing-based resource (re-)selection for sidelink reference signal;
determining a plurality of candidate resources for sidelink reference signal in a sidelink resource pool;
determining or deriving a specific candidate resource being indicated or reserved by a received Sidelink Control Information (SCI) from another UE;
excluding the specific candidate resource from the plurality of candidate resources;
excluding one or more additional candidate resources associated with the specific candidate resource from the plurality of candidate resources;
selecting one or more resources from remaining candidate resources after exclusion; and
performing one or more sidelink reference signal transmissions on the one or more resources.

20. The method of claim 19, wherein:
the one or more additional candidate resources are in a same occasion as the specific candidate resource; and/or
the one or more additional candidate resources and the specific candidate resource comprise one or more same Physical Resource Blocks (PRBs) or sub-channels in frequency domain; and/or
the one or more additional candidate resources and the specific candidate resource comprise different Resource Elements (REs); and/or
the one or more additional candidate resources and the specific candidate resource apply a same comb-N structure or design with different frequency or comb offsets; and/or
the one or more additional candidate resources comprise different REs which are at least adjacent, neighbored, or close to the specific candidate resource.
